(19) United States
(12) Patent Application Publication
(10) Pub. No.: US 2026/0212660 A1
(43) Pub. Date: Jul. 23, 2026

(54) SYSTEM AND METHOD FOR THERMAL VIDEO SURVEILLANCE BASED ON PYRAMIDAL POOLING ARCHITECTURE

(71) Applicant: Ashish GHOSH, Kolkata (IN)

(72) Inventors: Ashish GHOSH, Kolkata (IN); Badri Narayan SUBUDHI, Jagti (IN); Manoj Kumar PANDA, Rayagada (IN); T. Veerakumar, Ponda (IN); Vinit JAKHETIYA, Jagti (IN); S. Esakkirajan, Coimbatore (IN)

(21) Appl. No.: 19/026,922

(22) Filed: Jan. 17, 2025

(51) Int. Cl. G06V 10/82; G06V 10/764; G06V 10/77; G06V 20/40; G06V 20/52

(52) U.S. Cl. CPC G06V 10/82; G06V 10/764; G06V 10/7715; G06V 20/41; G06V 20/46; G06V 20/52

(57) ABSTRACT

The present invention provides systems and methods for thermal video surveillance that may include an encoder-decoder type deep learning model-based platform with a transfer learning strategy for foreground segmentation, where a modified ResNet-152 network is configured as an encoder that deeply learns and extracts the features at multiple levels. Further, a multiscale features extraction (MFE) block is integrated with the encoder network to enhance the feature learning capabilities that preserve sparse and dense deep features from challenging thermal scenarios. The pyramidal pooling architecture (PPA) in the MFE block is utilized as a suitable contextual prior. Furthermore, a decoder network is provided where up-sampling is performed to project the deep multi-scale features space to image-frame space.

### TECHNICAL FIELD

The present invention relates to a deep learning framework for thermal video surveillance. Particularly, the present invention relates to a system and method for thermal video surveillance based on pyramidal pooling architecture.

### DESCRIPTION OF THE RELATED ART

In the past few decades, research and development in automatic vision-based surveillance systems have been gaining popularity because of their massive real-time applications. Artificial intelligence-based computer vision surveillance systems enable the detection and monitoring of moving objects from video scenes. For the surveillance system, the visual sensor is an essential component. The visual sensor can capture the image in grayscale or RGB plane with detailed textural information and better spatial resolution. However, these kinds of images are immensely afflicted by variations in illumination. Furthermore, the visual sensor cannot provide better accuracy during nighttime due to low visibility. A thermal sensor may be preferred in an automatic surveillance system to facilitate continuous monitoring of the objects. Thermal sensors capture heat emitted by the object and are hence independent of the external sources. Based on their capability to sense the radiated heat, thermal sensors are found to be used in two varieties: active and passive thermal sensors. An active sensor emits infrared radiation and captures the radiation reflected by an object. Generally, the active sensors capture the radiation of both the near-infrared electromagnetic and the visible spectrums and are less reliant on illumination. However, passive thermal sensors are preferred in many applications as they capture heat radiated by the object, eliminating the dependency on external sources of energy. Yet, moving object detection from real-time thermal video scenes is arduous as in general a video scene is affected by dynamic background, missing information, adverse effects of weather conditions, poor resolution, low contrast, etc.

Background Subtraction (BS) is one of the highly cited approaches used for surveillance applications and is also termed a local change detection process. BS is a pixel labeling task and includes the steps of background construction and foreground segmentation. The accuracy of the moving object detection using a BS technique depends on the background construction. However, background construction is a challenging task, as there is high uncertainty in the video scenes. Also, most of the existing BS methods are scene-specific, and the outcomes of many algorithms are based on manual parameter tuning. Additionally, the accuracy of these traditional techniques depends on hand-crafted features.

In the last few years, Convolutional Neural Networks (CNNs) have been a go-to technique in the field of image processing and computer vision because of their capability to extract and learn low, mid, and high-level features from images. CNNs have found extensive application in the fields of object detection, object segmentation, and many other domains. Transfer learning can further strengthen it and significantly outperform more traditional methods in terms of performance. Deep CNN architectures determine the diverse features and then optimize them for the desired result. The deep CNN architecture is adaptable to various challenges in data too. However, it may be noted that the deep learning architecture for local change detection has different folds of disadvantages. One of the major challenges involved in deep learning-based surveillance is the complexity of the CNN architecture. It is found that as the number of layers increases the complexity of the algorithm increases tremendously. Similarly, it is observed that the number of training data required for deep learning is quite high, whereas in most of the videos getting foreground data for object detection is very low. Also getting an end-to-end network for object detection in state-of-the-art techniques is very rare. Meanwhile, the most generative adversarial network (GAN) is also used for local change detection. However, these networks are incapable of preserving sparse and dense features from the video scene.

CNN-based surveillance systems are available in prior art, for example, reference can be made to U.S. Pat. No. 10,289,936 B2 which discloses a surveillance system with landmark localization on objects in images using convolutional neural networks, wherein a processor is configured to form a multi-layer Convolutional Neural Network (CNN) which jointly models multiple intermediate shape concepts, based on the rendered synthetic images. The processor is also configured to perform an intra-class appearance variation-aware and occlusion-aware 3D object parsing on the actual image by applying the CNN to the actual image to generate an image pair including a 2D and 3D geometric structure of the object depicted in the actual image. The surveillance system further includes a display device configured to display the image pair. The goal is to perform object parsing, particularly for a surveillance system with landmark localization on objects in images using convolutional neural networks.

Another reference can be made to the prior art document “CNN-based thermal infrared person detection by domain adaptation”, by Christian Herrmann et al. (2018), which proposes a strategy to make use of CNN-based object detector frameworks which are pre-trained on visual RGB images. Two key steps are undertaken under this document, firstly, an appropriate preprocessing strategy for the IR data is suggested which transforms the IR data as close as possible to the RGB domain. This allows pre-trained RGB features to be effective in the novel domain. Secondly, the remaining domain gap is addressed by fine-tuning the pre-trained CNN on a limited set of thermal IR data. However, the shortcomings in the prior art for CNN-based thermal infrared detection by domain adaptation is that said technique uses a pre-processing strategy for the IR data which transforms the IR data as close as possible to the RGB domain, and the use of VGG-16 network in the said technique makes the model computationally expensive.

In view of the above existing image processing techniques and underlying problems, there is a need for a system and method for thermal video surveillance based on pyramidal pooling architecture.

### OBJECTIVES OF THE INVENTION

The primary objective of the present invention is to provide a system and method for thermal video surveillance based on pyramidal pooling architecture.

Another objective of the present invention is to provide an encoder-decoder-type deep learning architecture with a transfer learning strategy for foreground segmentation in an image dataset for thermal video surveillance.

Still, another objective of the present invention is to utilize a modified ResNet-152 network as an encoder that deeply learns and extracts the features from image datasets at multiple levels and implements a multiscale features extraction (MFE) block integrated with the encoder network to enhance the feature learning capabilities that preserve sparse and dense deep features from challenging thermal scenarios.

Other objectives and advantages of the present invention will become apparent from the following description taken in connection with the accompanying drawings, wherein, by way of illustration and example, the aspects of the present invention are disclosed.

### SUMMARY OF THE INVENTION

According to some embodiments of the present disclosure, systems, and methods are provided herein for thermal video surveillance that may include an encoder-decoder type deep learning model-based platform with a transfer learning strategy for foreground segmentation, where a modified ResNet-152 network is configured as an encoder that deeply learns and extracts the features at multiple levels. Further, a multiscale features extraction (MFE) block is integrated with the encoder network to enhance the feature learning capabilities that preserve sparse and dense deep features from challenging thermal scenarios. The pyramidal pooling architecture (PPA) in the MFE block is utilized as a suitable contextual prior. Furthermore, a decoder network is provided where up-sampling is performed to project the deep multi-scale features space to image-frame space.

The modified ResNet-152 encoder with the MFE block provides better accuracy with significantly increased depth and takes less time than traditional architecture as it utilizes fewer trainable parameters than the existing neural network. An end-to-end training mechanism is adapted to train the model, and a few input-ground-truth pair samples are used for the same. In some exemplary illustrations, the model is evaluated on the CDNet-2014 and TU-VDN datasets, and the results are graphically illustrated in FIGS. 5A and 5B.

### BRIEF DESCRIPTION OF DRAWINGS

The disclosure will provide details in the following description of the invention and the preferred embodiments with reference to the following figures wherein:

FIG. 1 illustrates a block diagram of the thermal video surveillance system.

FIG. 2 illustrates a block diagram of a multiscale features extraction module.

FIG. 3 illustrates a block diagram of pyramidal pooling architecture.

FIG. 4 illustrates a flow diagram of an algorithm depicting the detection of moving objects for thermal input images.

FIG. 5A illustrates an exemplary visualization of the original image, ground truth image, and detected results obtained using the CD-Net 2014 dataset.

FIG. 5B illustrates an exemplary visualization of the original image, ground truth image, and detected results obtained using the TU-VDN dataset.

### DETAILED DESCRIPTION OF THE INVENTION

The following description describes various features and functions of the disclosed system and method with reference to the accompanying figures. In the figures, similar symbols identify similar components, unless context dictates otherwise. The illustrative aspects described herein are not meant to be limiting. It may be readily understood that certain aspects of the disclosed system and method can be arranged and combined in a wide variety of different configurations, all of which are contemplated herein. Accordingly, those of ordinary skill in the art will recognize that various changes and modifications of the embodiments described herein can be made without departing from the scope of the invention. In addition, descriptions of well-known functions and constructions are omitted for clarity and conciseness.

Features that are described and/or illustrated concerning one embodiment may be used in the same way or in a similar way in one or more other embodiments and/or in combination with or instead of the features of the other embodiments.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purposes only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps, or components but does not preclude the presence or addition of one or more other features, integers, steps, components or groups thereof. The equations used in the specification are only for computation purposes.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

Embodiments of the present invention are described below by way of example only. These examples represent the best ways of putting the invention into practice that are currently known to the Applicant although they are not the only ways in which this could be achieved. Forth the functions of the example and the sequence of steps for constructing and operating the example.

In embodiments, provided herein are the thermal video surveillance systems and methods disclosed that may be implemented using hardware, software, firmware, and/or any combination thereof. In a preferred embodiment, a thermal image is processed as an input to an end-to-end deep learning framework via internal or external storage means of a computing device. The computing device is selected from but not limited to a computer, a laptop, or a tablet device. The storage means are selected from but not limited to, random access memory (RAM), read-only memory (ROM), Hard Disk or solid-state drive (SSD), USB drive, or SD card. The framework may be stored in the storage means of the computing device. The computing device may include a processing unit and the processing unit is configured to run/execute the end-to-end deep learning framework responsive to the user input. In a non-limiting example, the present invention may be implemented using the NVIDIA Jetson Xavier NX Developer Kit which includes a power-efficient, compact Jetson Xavier NX module for Artificial Intelligence (AI) edge devices.

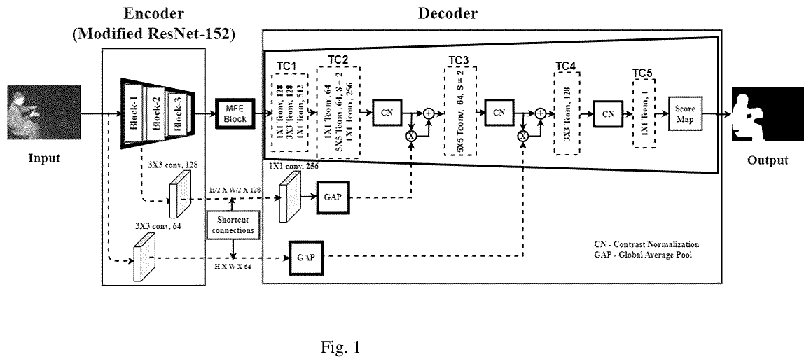

FIG. 1 illustrates a block diagram of the thermal video surveillance system. Initially, an input thermal image is given to a modified ResNet-152 deep learning framework. The modified ResNet-152 network is configured as an encoder and is capable of retaining low, mid, and high-level features. Further, the extracted features are provided to a multiscale features extraction (MFE) block that captures the multi-scale moving objects from the challenging thermal image accurately. Finally, the multiscale feature maps from the MFE block are provided to a decoder network that projects feature space to image space efficiently.

In a preferred embodiment, a modified ResNet-152 network may be provided as an encoder. It may be appreciated by the person skilled in the art that a typical ResNet-152 network operates on a deep residual learning framework and is widely used for several computer vision applications. The present invention utilizes the capabilities of a typical ResNet-152 network for local change detection. The typical ResNet-152 network consists of five blocks, where each block has a stack of convolutional layers, batch normalization layers, and a rectified linear unit (ReLU) as an activation function. The convolutional layers are capable of extracting the spatial information of the input image by using convolutional kernels. The batch normalization layers are utilized in the deep neural network, which boosts the training speed with a faster learning rate. The use of ReLU in the network makes it faster and more efficient. Moreover, transfer learning may be utilized by the present invention. Transfer learning is a mechanism that converges knowledge from the source domain to the target domain. The use of transfer learning explores new tasks that depend on formerly acquired jobs by the deep ResNet-152 network. Additionally, it makes the model accurate and faster while training on fewer samples.

In the present disclosure, the modified Resnet-152 network incorporates three blocks. The weights of the first two blocks are kept the same as those of a pre-trained ResNet-152 network. The weights of the third block of the encoder network are learned by using the transfer learning mechanism that boosts the performance of the claimed system. The max-pooling layer is removed between the first two blocks to increase the use of deep multi-layer features with high spatial resolution. Also, the fourth and fifth blocks of the typical ResNet-152 network are removed to enhance the use of high spatial resolution and high-frequency components. To use the low-level feature, a 3×3 convolution layer with 64 filters at the beginning of the first block and a 3×3 convolution layer with 128 filters are introduced at the end of the first block of the modified ResNet-152 encoder network. These low-level features are propagated towards a decoder network through shortcut connections followed by global average pooling that improves the feature representation. In the modified ResNet-152 encoder network, a thermal image is provided as an input with size H×W. Here H×W denotes the dimensions of the input image. The claimed system does not employ any form of data pre-processing strategy for the encoder input.

Initially, the 3×3 convolution layer with 64 filters at the beginning of Block-1 of the modified ResNet-152 network projects the image space with dimensions H×W to H×W×64 feature space. Further, Block-1 of the modified ResNet-152 network extracts features from H×W to H/2×W/2×64. Further, it is fed to a 3×3 convolution layer with 128 filters which projects the feature space from H/2×W/2×64 to H/2×W/2×128. Subsequently, the output of Block-1 is provided to Block-2 which projects the feature space from H/2×W/2×64 to H/2× W/2×256. Henceforth, the output of Block-2 is provided to Block-3 which projects feature space from H/2×W/2×256 to H/4×W/4×512. Due to the use of a selected number of layers by the modified ResNet-152 network architecture with a fewer number of trainable parameters, the architecture implemented by the present invention becomes less complex against competitive architectures, for example, VGG-16 and VGG-19-based CNN models. Trainable parameters are the ones that the model adjusts or learns during the training process to minimize the difference between predicted and actual outputs. They are updated iteratively through optimization algorithms to improve the model's performance. During the training phase, the model learns optimal values for these parameters to make accurate predictions on the training data. Non-trainable parameters, also known as fixed parameters, are constants or configurations that remain unchanged throughout the training process. These parameters are pre-defined and do not get updated during training. They are typically set before training and are not updated based on the input data. Non-trainable parameters are crucial in defining the model architecture and the training process itself, but they do not undergo adjustments or learning based on the training data.

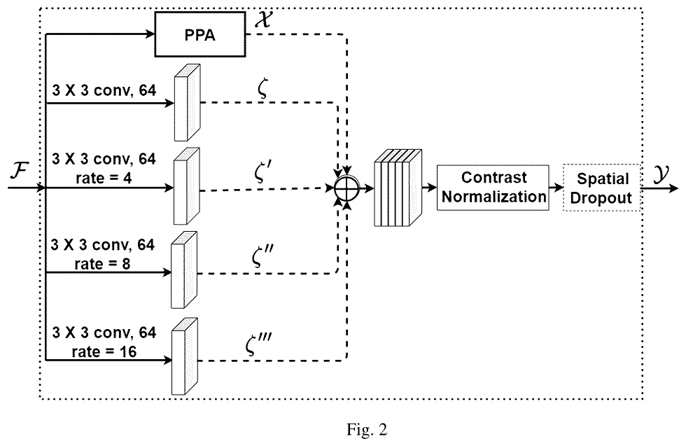

FIG. 2 illustrates a block diagram of a multiscale features extraction (MFE) module. Here, F represents the deep features that are extracted from the encoder and given to the MFE block. The MFE block is a hybridization of a pyramidal pooling architecture (PPA), a convolutional layer, and various atrous convolutional layers that accurately capture the multi-scale moving objects from challenging input thermal images. The modified ResNet-152 encoder with the MFE block is capable of retaining suitable multi-scale features for thermal video surveillance.

The MFE block is introduced between the encoder-decoder network to preserve contextual information from the deep multi-layer features. The deep feature maps (F) of size H/4×W/4×512 from the encoder network are given to an MFE block. Here, H×W denotes the dimension of the input image. The contextual relationship among the pixels of video scenes is an important element in local change detection, and the lack of this may lead to many isolated points as missed/false alarms in the foreground map. In the present invention, the PPA module acts as a suitable contextual prior. The MFE block has a convolutional layer to preserve the sparse information and various atrous convolutional layers to preserve dense features. The use of a convolutional layer and different atrous convolutional layers in the MFE block learns a mapping from high-level feature space to sparse and dense feature space. Hence, the MFE block represents the features in a better way that is essential for local change detection.

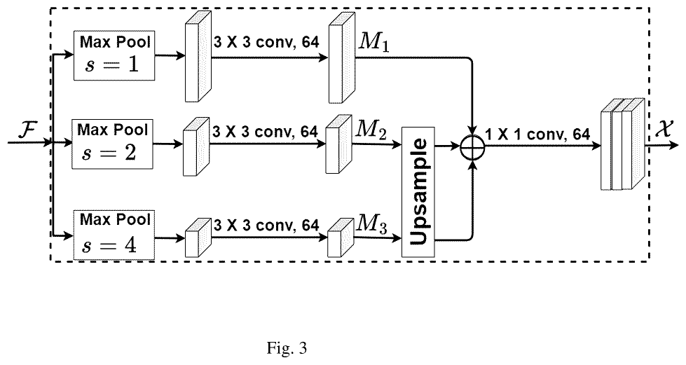

FIG. 3 illustrates a block diagram of a pyramidal pooling architecture (PPA). The PPA module consists of three max-pooling layers with strides of 1, 2, and 4, followed by 3×3 convolutional layers, with 64 filters which keep the maximum information and detect the patterns in the challenging videos accurately. The max-pooling layer is utilized to preserve useful information in every pooling block and decrease the dimension of feature maps. The filter size for the max-pooling layers is considered to be 2×2. The PPA module preserves the contextual relationship of the thermal image which is essential for moving object detection. The PPA module learns more complex features that improve the accuracy and reduce noise efficiently which leads to a reduction of false detection in the extracted result.

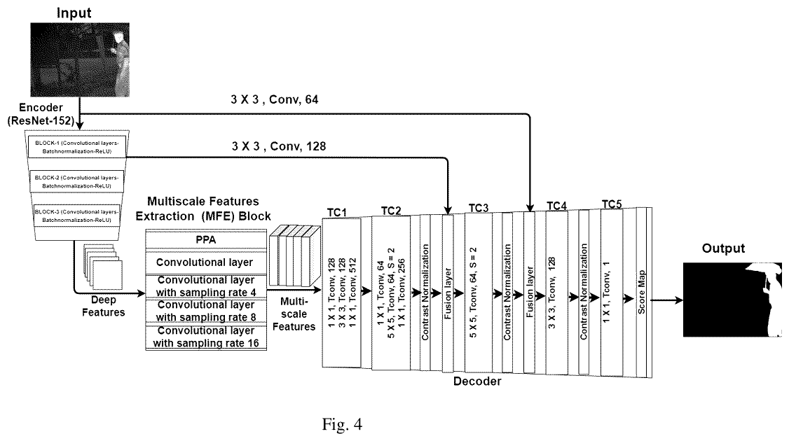

FIG. 4 illustrates a flow diagram depicting the detection of moving objects for thermal input images. The modified ResNet-152 network is followed by the MFE block which is a hybridization of the PPA module, a convolutional layer, and various atrous convolutional layers where the high-level features from the encoder network are utilized to extract features at various scales. The use of the PPA in the MFE block preserves maximum value in every pooling area to retain the contextual relationship between the pixels in the complex video frames that can handle various challenging scenes. The decoder network consists of stacked transposed convolution layers that project from feature space to image space, predicting a score map. In an exemplary embodiment, a threshold of 0.9 is applied on the score map to get the binary class labels as the background and foreground. Here, the thresholding process involves comparing each pixel's intensity value within the score map to a designated threshold. Pixels exceeding the threshold value are identified as constituents of the foreground or the targeted object, while those falling below the threshold are recognized as elements of the background. It may be observed that a threshold of 0.9 effectively isolates score map pixels associated with moving objects as well as background, demonstrating a decrease in noise.

In accordance with FIGS. 1 and 4, a decoder network containing stacked transposed convolution layers is illustrated. In embodiments, the decoder network may be provided to effectively project the feature space into the image space. The decoder network efficiently projects the output of the MFE block from feature space into image space and generates a dense probabilistic mask. Multiscale feature maps from an MFE block (Y) of size H/4×W/4×320 followed by contrast normalization (CN) layer and spatial dropout layer with a rate of 0.25 are provided to the decoder network to generate a score map, which consists of five blocks namely: TC1, TC2, TC3, TC4, and TC5. In the present invention, the deep feature maps (F) of size H/4×W/4×512 from the encoder network are given to an MFE block as illustrated in FIG. 2. The MFE block contains a pyramidal pooling architecture (PPA), a convolutional layer, and various atrous convolutional layers. The PPA block shown in FIG. 3 consists of three max-pooling layers with strides(s) of 1, 2, and 4 followed by 3×3 convolutional layers, with 64 filters. The max-pooling layer is utilized to preserve useful information in every pooling block and decrease the dimension of feature maps. The max-pooling layers filter size is 2×2. The output of the max-pooling layers followed by 3×3 convolutional layers with 64 filters are represented as M₁, M₂, and M₃. The dimension of M₁ same as input deep feature maps F, whereas the dimensions of M₂ and M₃ are reduced by 2 and 4, respectively. Therefore, the dimensions of M₂ and M₃ are up-sampled and concatenated with M₁ along the depth dimension followed by ReLU as well as a 1×1 convolutional layer with 64 filters representing the output of the PPA block. Again, the feature maps F from the encoder network are given to a 3×3 convolutional layer with 64 filters which will preserve the sparse information of the deep features, and three 3×3 convolutional layers each consisting of 64 filters, with dilation rates of 4, 8, and 16. Here the convolutional layers with different dilation rates are called atrous convolution, which retains the dense information of the deep features. Hence, in the MFE architecture, the PPA block preserves the 64 features with useful information, a convolutional layer retains 64 sparse features, and the three atrous convolutional layers each capable of retaining 64 dense features. Then all the features are concatenated along the depth dimension that produces H/4×W/4×320 features. These features followed by the CN layer and spatial dropout layer with a rate of 0.25 produce the multi-scale features with size H/4×W/4×240 where the spatial dropout layer with a rate of 0.25 randomly drops the 25% of features out of 320 features.

The TC1 block contains a stack of two 1×1 and a 3×3 transposed convolutional layers with s=1. The main motive of the 1×1 transposed convolutional layer is to project the higher dimensional feature space into the lower dimensions. Also, the use of a 1×1 transposed convolutional layer reduces the computational complexity of the network. Further, the use of the 3×3 transposed convolutional layer can extract the spatial information of the feature maps. Therefore, the stacked 1×1 and 3×3 transposed convolutional layers produce a robust network while performing on fewer parameters. Initially, the features from an MFE block operated with TC1 block to project the feature space from H/4×W/4×240 to H/4×W/4×512. TC2 block consists of a similar arrangement as the TC1 block of layers except that the present invention utilizes 5×5 instead of 3×3 transposed convolutional layers with s=2. This block projects the feature space from H/4×W/4×512 to H/2×W/2×256. The feature maps from the TC2 block followed by contrast normalization (CN) and ReLU function are fused with low-level features to boost the feature representation. These low-level features are pulled at the end of the first block of the encoder by utilizing a 3×3 convolutional layer with 128 filters. Subsequently, these features are propagated towards the decoder through a shortcut connection followed by a 1×1 convolutional layer, 256 filters with global average pooling (GAP). The use of GAP improves the performance of the model, which is robust to spatial translations of the low-level features. Further, the fused feature maps are given to the TC3 block, which consists of a 5×5 transposed convolutional layer, and 64 filters with s=2. TC3 block is used to expand the feature maps to a size of H×W×64. The feature maps from the TC3 block followed by the CN and ReLU function are fused with low-level features that are pulled from the beginning of the first block of an encoder. These low-level features are generated using a 3×3 convolutional layer with 64 filters, guided towards the decoder through a shortcut connection followed by a GAP layer. Further, the fused features are processed through the TC4 block, followed by CN and ReLU functions, which project 64 feature maps to 128 feature maps. It may be observed that the 128 feature maps in this block provide a better representation of each pixel and improve the efficacy of the claimed system. Finally, in the TC5 block, the 128 feature maps are projected to 1 feature map by utilizing a 1×1 transposed convolution layer with s=1 followed by a sigmoid activation function. The TC5 block generates a score map that predicts each pixel value's probability in the range [0, 1]. Later, a threshold value is applied to classify each pixel on the score map, either belonging to foreground or background. Moreover, ReLU non-linearity is added to every transposed convolutional layer in TC1, TC2, and TC3. Also, to mitigate over-fitting in the model, L2 is used to regularize the weights of the first layer of TC1, TC2, and the 5×5 transposed convolutional layer of TC3 block. L2 regularization, also known as weight decay, is a common strategy used in the decoder network to prevent overfitting. The regularization term is added to the loss function, penalizing large weights in the neural network. The regularization term is proportional to the squared magnitudes of the weights in the network.

In the decoder network, the stacked transposed convolutional layers upscale the feature space into the probability mask that retains both foreground and background information accurately. Also, the use of contrast normalization in the decoder network helps to stabilize the training process by reducing internal covariate shifts and improving the performance of the model by enabling better generalization. In the present invention, the encoder-decoder type model takes a thermal image as the input and provides a foreground-segmented probability mask for the corresponding thermal image.

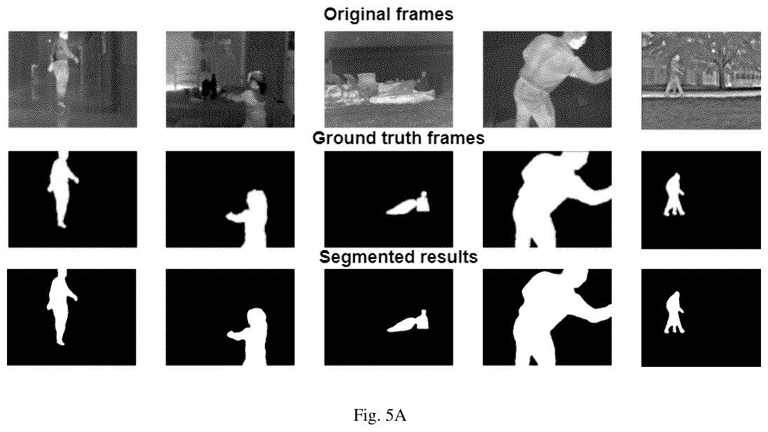

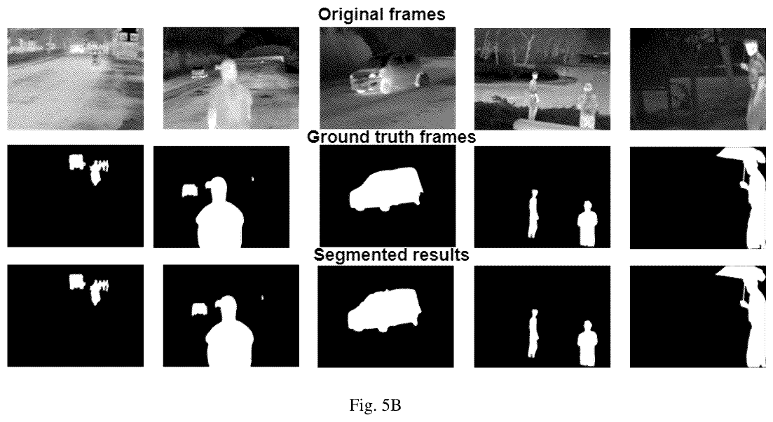

FIG. 5A depicts the visualization of the original image, ground truth image, and detected results obtained using the CD-Net 2014 dataset. FIG. 5B depicts the visualization of the original image, ground truth image, and detected results obtained using the TU-VDN dataset. To validate the effectiveness of the present invention, different experiments are performed with the benchmark datasets: the CD-Net 2014 dataset and the TU-VDN dataset. In the first stage of the experiment, the CD-Net 2014 dataset is used which consists of five thermal videos with various challenges including low resolution (or) missing information, low signal-to-noise ratio, lack of structure such as shape and textural information, lack of color information, and low contrast, etc. In the next stage of the experiment, the TU-VDN database is used which contains different outdoor night videos captured by a FLIR-t650sc camera of four different categories: dust, fog, rain, and low light. The image sequences are captured under various atmospheric conditions such as dusty, rainy, and foggy with key challenges like flat cluttered backgrounds and dynamic backgrounds under the static camera. From FIGS. 5A and 5B, it may be observed that the present invention provides adequate accuracy for both the CD-Net 2014 dataset and the TU-VDN dataset.

The present invention solves the technical problem of how to detect features of moving objects in challenging thermal videos including dynamic background, low resolution (or) missing information, low signal-to-noise ratio, lack of structure such as shape and textural information, lack of color information, and low contrast, etc. The present invention solves this problem by providing better accuracy. The systems and methods disclosed by the present invention provide a thermal video surveillance system wherein a modified ResNet-152 network is induced with a feature extraction module to retain significant features at multi-scales from the input thermal image. In addition, a decoder network is also developed to get the probability mask from the high-dimensional feature space.

The present invention provides advantages over the existing state-of-the-art techniques for thermal video surveillance in challenging scenes and provides better accuracy. The present invention is capable of handling challenging thermal video scenes such as dynamic background, low resolution (or) missing information, low signal-to-noise ratio, lack of structure such as shape and textural information, lack of color information, and low contrast, etc., and provides better accuracy over existing state-of-the-art techniques.

In an exemplary embodiment, a quantitative comparison of thermal sequences of the present disclosure with non-deep learning and deep learning-based state-of-the-art techniques carried on the CDNet-2014 dataset is illustrated in Table 1.

TABLE 1

| | | Avg. | Avg. | Avg | Avg. |
|---|---|---|---|---|---|
| | Approaches | Precision | Recall | F-measure | PWC |
| Non-deep | Fuzzy Mode | 0.9344 | 0.9766 | 0.9550 | 1.1130 |
| learning | KDE | 0.8974 | 0.6725 | 0.7423 | 1.6795 |
| | GMM | 0.8652 | 0.5691 | 0.6621 | 4.2642 |
| | PAWCS | 0.8280 | 0.8504 | 0.8324 | 1.4018 |
| | SuBSENSE | 0.8328 | 0.8161 | 0.8171 | 2.0125 |
| | SOBS-CF | 0.8715 | 0.6347 | 0.7140 | 1.8021 |
| | WeSamBE | 0.8554 | 0.7727 | 0.7962 | 2.3538 |
| | Multimode | 0.8268 | 0.8162 | 0.8194 | 1.4289 |
| | Background | | | | |
| | Shared | 0.8072 | 0.8618 | 0.8319 | 1.8656 |
| | Model | | | | |
| | Spectral-360 | 0.9114 | 0.7238 | 0.7764 | 1.6337 |
| Deep | DeepBS | 0.9257 | 0.6637 | 0.7583 | 3.5773 |
| learning | WisenetMD | 0.8696 | 0.7867 | 0.8152 | 1.8993 |
| | Cascade CNN | 0.8577 | 0.9461 | 0.8958 | 1.0478 |
| | IUTIS-5 | 0.8969 | 0.7990 | 0.8303 | 1.1484 |
| | BSUV-Net | 0.8551 | 0.8739 | 0.8581 | 1.7058 |
| | SemanticBGS | 0.9118 | 0.7664 | 0.8219 | 1.3897 |
| | BSUV-Net 2.0 | 0.9359 | 0.8594 | 0.8932 | 1.1659 |
| | BSPVGAN | 0.9770 | 0.9763 | 0.9764 | 0.2406 |
| | MU-NET1 | 0.9799 | 0.9852 | 0.9825 | 0.1389 |
| | Proposed | 0.9958 | 0.9912 | 0.9935 | 0.0564 |

Table 1 illustrates different parameters including Average precision (Avg. Precision), average recall (Avg. Recall), average F-measure (Avg. F-measure), and average percentage of wrong classification (Avg. PWC) where quantitative measures are utilized to show the effectiveness of the present invention over the existing state-of-the-art techniques. The efficacy of the present invention may be validated through diverse quantitative assessments, including Avg. Precision, Avg. Recall, Avg. F-measure, and Avg. PWC. The superior performance of any moving object detection scheme is indicated by higher values for Avg. Precision, Avg. Recall, and Avg. F-measure, along with a lower value for Avg. PWC. Precision is delineated as the fraction of retrieved instances that are relevant, while Recall is defined as the fraction of relevant instances that are successfully retrieved. The F-Measure combines both Precision and Recall, representing their harmonic mean. The percentage of misclassifications is characterized as the ratio of instances misclassified to the total instances. These evaluation metrics can be computed as follows:

$$F - measure = \frac{2 \times Precision \times Recall}{Precision + Recall}$$

$$where , Precision = \frac{T P}{T P + F P} and Recall = \frac{T P}{T P + F N}$$

$$PWC = \frac{100 \times ( F P + F N )}{F P + F N + T P + T N}$$

From Table 1, it may be observed that, in terms of Avg. Precision, Avg. Recall, Avg. F-measure, and Avg. PWC, the model utilized by the present invention surpasses the nineteen state-of-the-art techniques, wherein the model has attained higher values of Avg. Precision, Avg. Recall, Avg. F-measure, and lower value of Avg. PWC as 0.9958, 0.9912, 0.9935, and 0.0564 respectively.

Table 2 illustrates parameters comparison among the VGG-16, VGG-19, and ResNet-152 deep neural networks.

TABLE 2

| Parameters | VGG-16 | VGG-19 | ResNet-152 |
|---|---|---|---|
| Trainable parameters | 5,899,776 | 8,259,584 | 2,339,840 |
| Non-trainable | 1,735,488 | 2,325,568 | 333,504 |
| parameters | | | |
| Total parameters | 7,635,264 | 10,585,152 | 2,673,344 |

As shown in Table 2, the number of trainable and non-trainable parameters used in the model using the modified ResNet-152 architecture is reduced by at least 3 to 4 times compared to the VGG-16 and VGG-19 deep learning architectures. One of the major advantages of the present invention is the high reduction of the parameters used in the modified ResNet-152 deep learning architecture against the VGG-16 and VGG-19 deep learning architectures. Therefore, the present invention may be considered for many real-time applications as it takes less time as compared to the competitive architecture.

In some embodiment, the present invention implements a modified ResNet-152 network and provides various advantages over existing state-of-the-art techniques. For example, the advantages of utilizing the modified ResNet-152 network in the thermal surveillance systems and methods are: (i) more stable and efficient, (ii) deeper blocks of the ResNet-152 network gradually learn more complex features that provide improved performance, (iii) lower blocks of the ResNet-152 network can learn and extract high spatial resolution features with low-level local features such as edges, colors, and textures, while the deeper blocks learn and extract high-level global features like objects and events with lower spatial resolution, (iv) computational complexity of the ResNet-152 network is quite less with a higher number of layers, and (v) the ResNet-152 network uses the stacked residual networks with identity mapping to tackle the vanishing gradient problem and hence, provides better accuracy.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

We claim:

1. A system for thermal video surveillance comprising one or more processors and a memory, wherein computer programs are stored in the memory, that when executed by one or more processors, cause one or more processors to:
provide input data comprising one thermal image to an encoder, wherein the encoder is configured to extract feature information including low, mid, and high-level features from the input data;
use a multi-scale feature extraction module coupled with the encoder to receive the feature information of the input data that captures the multi-scale features of moving objects from the thermal image based on the received feature information, the multi-scale feature extraction module comprising a pyramidal pooling architecture (PPA) module, a convolutional layer and plurality of atrous convolutional layers that accurately captures the multi-scale moving objects from the thermal image, wherein
the PPA module preserves the contextual relationship of the thermal image which is essential for moving object detection,
the PPA module comprises three max-pooling layers with corresponding strides followed by a plurality of convolutional layers, and
the PPA module retains maximum value in every pooling area to retain the contextual relationship between the pixels in the complex video frames that can handle various challenging scenes; and
utilize a decoder that is configured to perform up-sampling to project the multi-scale features space to image space, wherein the decoder includes a plurality of stacked transposed convolution layers that project from feature space to image space, predicting a score map and a threshold of 0.9 is applied on the score map to get one binary class label as background and foreground.

2. The system as claimed in claim 1, wherein the encoder is a pre-trained ResNet-152 network comprises three blocks including Block-1, Block-2, and Block-3, and the encoder is configured to maintain the weights for Block-1 and Block-2 same as of the pre-trained ResNet-152 network and the weights of Block-3 are learned using transfer learning.

3. The system as claimed in claim 1, wherein the max-pooling layer is utilized to preserve useful information in every pooling block and decrease the dimension of feature maps.

4. The system as claimed in claim 1, wherein the strides in three max-pooling layers of the PPA module are 1, 2, and 4, followed by 3×3 convolutional layers, and 64 filters.

5. A method of thermal video surveillance, performed by one or more processors and a memory of a computing unit, the method comprising:
i. receiving input data including one thermal image by an encoder, wherein the encoder is configured to extract feature information including low, mid, and high-level features from the input data;
ii. capturing multi-scale features from the thermal images based on the received feature information, the multi-scale feature extraction module comprising a pyramidal pooling architecture (PPA) module, a convolutional layer, and a plurality of atrous convolutional layers that accurately captures the multi-scale moving objects from the thermal image;
iii. preserving the PPA module a contextual relationship of the thermal image which is essential for moving object detection;
iv. providing three max-pooling layers with corresponding strides followed by a plurality of convolutional layers in the PPA module;
v. preserving maximum value by the PPA module in every pooling area to retain the contextual relationship between the pixels in the complex video frames that can handle various challenging scenes; and
vi. perform up-sampling by a decoder to project the multi-scale features space to image space, wherein the decoder includes a plurality of stacked transposed convolution layers that project from feature space to image space, predicting a score map and a threshold of 0.9 is applied on the score map to get one binary class labels as background and foreground.

6. The method as claimed in claim 5, wherein the encoder is a pre-trained ResNet-152 network comprising three blocks including Block-1, Block-2, and Block-3, and the encoder is configured to maintain the weights for Block-1 and Block-2 same as of the pre-trained ResNet-152 network and the weights of Block-3 are learned using transfer learning.

7. The method claimed in claim 5, wherein the max-pooling layer is utilized to preserve useful information in every pooling block and decrease the dimension of feature maps.

8. The method claimed in claim 5, wherein the strides in three max-pooling layers of the PPA module are 1, 2, and 4, followed by 3×3 convolutional layers, and 64 filters.

9. A computer program product comprising computer-readable instructions for implementing the method of claim 5 on a computer or a processing device.
